(19) United States
(12) Patent Application Publication
(10) Pub. No.: US 2026/0162047 A1
(43) Pub. Date: Jun. 11, 2026

(54) AUTONOMOUS SYSTEM FOR FORMULATING COMPOSITIONS FROM MULTIPLE COMPOUNDS

(71) Applicant: Joseph Trygar, Pleasant Prairie, WI (US)

(72) Inventor: Joseph Trygar, Pleasant Prairie, WI (US)

(21) Appl. No.: 18/969,882

(22) Filed: Dec. 5, 2024

(51) Int. Cl. G06Q 10/08; G06Q 50/04

(52) U.S. Cl. CPC G06Q 10/08; G06Q 50/04

(57) ABSTRACT

A robotic system empowered by artificial intelligence to autonomously formulate compositions from multiple compounds.

### BACKGROUND OF THE INVENTION

The present invention relates to methods and systems for formulating a topical, consumable, or ingestible composition made from multiple compounds and, more particularly, a robotic system empowered by artificial intelligence to autonomously formulate compositions from raw ingredients.

The cost to produce a new product formulation in the drug, cosmetic, CBD, chemical, nutraceutical, and/or food industry is astronomical ranging from $5,000.00 for a new supplement to greater than $100,000.00 for a new drug. Furthermore, the time it takes to create a new formulation in these markets takes from two weeks to two years.

The reasons for the high costs and long turnaround times are that the current formulation process is done manually by humans, making it costly, slow, and wasteful. And since current methods are set up to make a single formulation at a time, if the resulting formulation is incorrect for any reason the process must start over, requiring redundant rework and significant additional costs.

As can be seen, there is a need for a robotic system empowered by artificial intelligence to autonomously formulate compositions from multiple compounds and raw ingredients.

### SUMMARY OF THE INVENTION

The present invention embodies artificial intelligence (AI) robotics and associated software that autonomously produces formulations for drugs, nutraceuticals, chemicals, food, CBD, and cosmetics. The system itself uses 85% less space than conventional manufacturing methods and it uses 98% less human labor for production. Moreover, the time it takes to produce a formulation is 90% faster than current methods and with near zero waste. Thereby, the present invention also reduces inventory needs by 45%, and these waste reductions create exponential savings in time, materials, and costs.

Artificial intelligence describes the work processes of our robotics that would require intelligence if performed by humans (Wisskirchen et al., 2017). The term ‘artificial intelligence’ thus means we have created intelligent robotic problem-solving behavior and an intelligent computer system. The robot is a multifunctional manipulator designed to move material, parts, tools, or specialized devices through various programmed motions for the performance of a variety of tasks.

As a result, the present invention produces a formulation in under three minutes instead of taking weeks or months to develop, and if the formulation is incorrect or needs to be redone it can be redone immediately in under three minutes, so that the time and cost savings are exponential in comparison to the prior art.

The present invention is autonomous and uses AI robotics as compared to current methods of human labor or semi-automatic equipment. The system embodied by the present invention can run 24/7 with no down time. It requires no supervision, and no labor, to reduce overall costs by more than 35% for short run production or full manufacturing, and it reduces time to formulate by upwards of 90%.

The solution embodied in the present invention produces a topical, consumable or ingestible composition formulation for under $5.00. This includes the complete formulation, bottle, cap, and labeling.

In addition, we tie the front-end robots to back-end Supply Chain Optimization robotics that also use AI and machine language (ML) to optimize the supply chain by predicting product demand for inventory and ensuring that the right products are available at the right time for dispensing. This helps reduce inventory costs and improve overall efficiency even more.

In one aspect of the present invention, a system for autonomously formulating a topical, consumable, or ingestible composition tailored to a consumer, the system includes the following: an input device configured to receive one or more composition parameter from the consumer; a recommendation module configured to receive the one or more composition parameter and composition, in part by referencing a composition or recipe database, a formula of two or more compounds, wherein each compound is associated with one or more composition parameter by the recommendation module; a station is comprised of a programmable front-end robot and a plurality of compounds, wherein the front-end robot is programmed via artificial intelligence to formulate the composition based on said formula; a laser-based labeling component is configured to label a container and the robot caps the product sealing the composition from the external environment, wherein the label comprises label parameters; and a logistics center comprising a back-end robot with an operatively associated reader, wherein the reader is configured to read and process the label parameters into a set of instructions, and wherein the back-end robot is configured to sort, track and serialize each container based on the set of instructions, whereby a conveyor system interconnects the front-end formulation robot to the back-end logistics robot to form a complete end-to-end production and logistics center.

In another aspect of the present invention, the system for autonomously formulating a topical, consumable, or ingestible compositions tailored to an individual or specific consumer further includes an input device that is comprised of a facial or biologic scanner configured to determine one or more dermatological or biological properties of the consumer, and wherein the composition parameters comprises the one or more dermatologic or biologic properties of the individual subject or customer.

These features, aspects and advantages of the present invention will become better understood with reference to the following drawings, description and claims.

### BRIEF DESCRIPTION OF THE DRAWINGS

FIG. 1 is a perspective view of an exemplary embodiment of an operating environment of an automated formulation and delivery system of the present invention, illustrating a robotic front end of a setup of key inventive components.

FIG. 2 is an exemplary flow chart of the present invention.

FIG. 3A is a perspective view of an exemplary embodiment of the present invention, illustrating a robotic logistics center 20 of the back-end of the system.

FIG. 3B is a perspective view illustrating an interior of the robotic logistics center 20 of FIG. 3A.

FIG. 4 is an exemplary flow chart of the present invention.

FIG. 5 is an exemplary floor plan of prior art composition manufacturing and logistics facilities whose footprints require over 125,000 square feet. In comparison, the footprint of the front-end formulation center/operating theater—see FIG. 1—is approximately 120 square feet and the footprint of the back-end logistics center—see FIG. 3A—of the present invention has a footprint of approximately 100 square feet, whereby a conveyor belt directly connects the front-end formulation center to the back-end logistics center so that the total footprint of a composition manufacturing and logistics facilities of the present invention is less than 300 square feet.

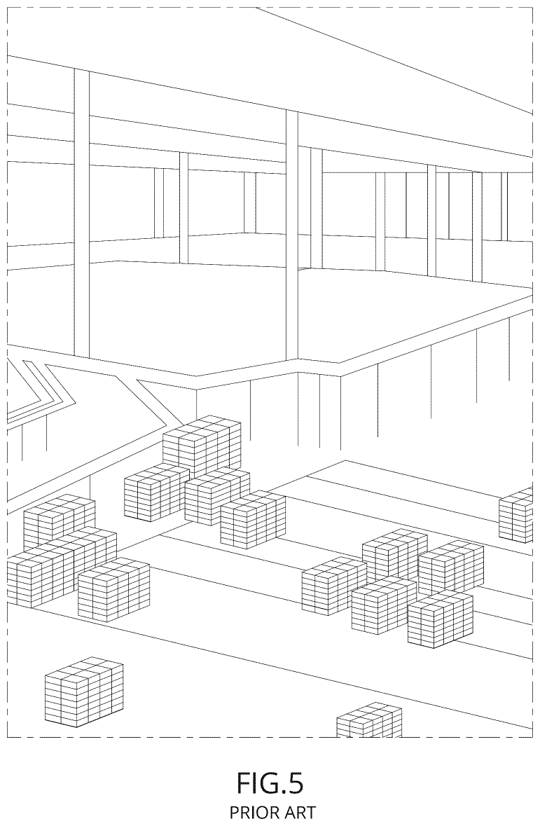

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, an embodiment of the present invention provides a robotic system empowered by artificial intelligence to autonomously formulate compositions from multiple compounds.

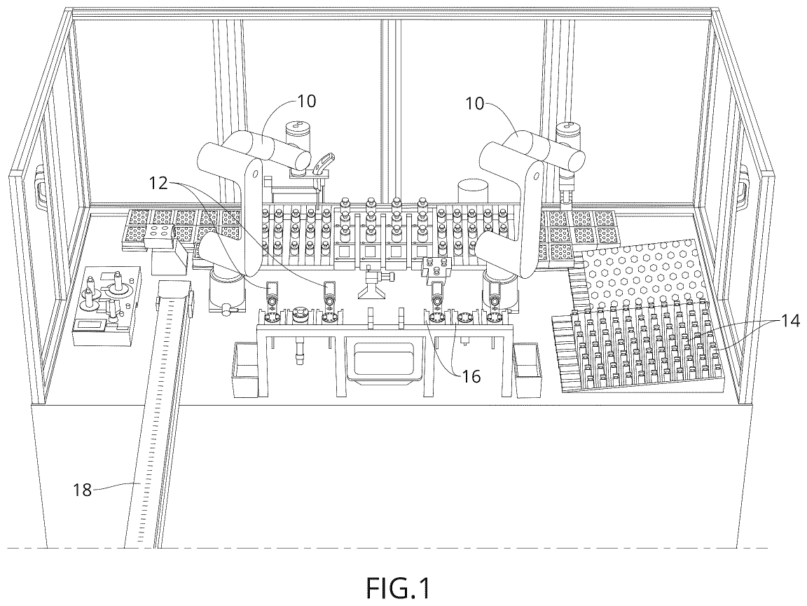

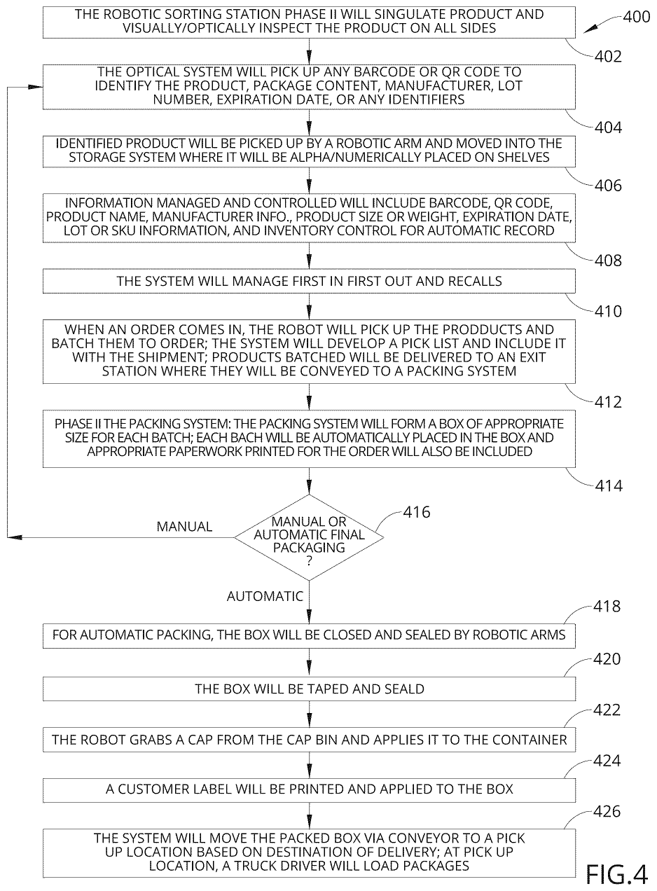

Referring to FIGS. 1 through 4, the present invention may include an autonomous formulation process for compositions embodying a robotic system empowered by artificial intelligence. Broadly speaking, the autonomous formulation process incorporates the steps of providing the operating environment of the robotic system with multiple compounds, empty containers 14, pipettors 12, bottle caps, pipettor racks 16, and then inputting formulation data into a central control system of the robotic system, wherein the central control system processes instructions for execution for selectively producing compositions—by way of a robotic arm 10 and conveyors 18 of the operating theatre—from the multiple compounds provided to the operating environment. The central control system is likely operatively associated with a remote computing device for an operator to input instructions and data into the central control system to control the robotic aspects of the overall system.

The automated formulation process incorporates a manufacturing system capable of creating cosmetics, supplements, chemical mixtures, and drug formulations on demand from an onboard supply of ingredients. The systemic components may include a programmable collaborative robotic arm 10 equipped with sensors and software that ensures safe behavior. Other systemic components may include a robot controller and machine learning to teach and send robotic arm 10 to desired positions to produce specific functions. The teach pendant may be equipped with a 3-position ‘dead-man’ switch. The teach pendant may be disconnected after programming and the robot then runs on the program that has been installed in its controller. However, a computer is often used to ‘supervise’ the robot and any peripherals, or to provide additional storage for access to numerous complex paths and routines.

The other systemic components include (a) the manual pipettors 12 configured to maximize efficient sip and spit routines for the finite measurement of ingredients. Pipettors are manipulated by the robotic arm 10; (b) heating block (for heating thick products to a more viscous state for mixing); (c) automated or liquid dispensers; (d) vortex mixer; (e) peristaltic pump; (f) laser engraver; (g) reaction vials for solvent containment; (h) pipette tips; (i) input containers 14 for ingredients or reagents; (j) conduit connectors for closed-system connections; (k) bulk liquid storage containers for water, alcohol, liquid precursors, or the like; (l) waste capture containers to collect used pipette tips; and weigh scales. The input containers 14 may require to be heated on a heated block during the formulation process.

The systemic components enable multiple sequential process functions and steps, including a machine input function and supplying raw materials for the onboard containers prior to operation.

In one embodiment, an operator picks a workflow selection, formulation, or product formula function, to initiate workflow for compounding, formulation or production of specific products via a single product formulation process, short run production or full-scale manufacturing, wherein, through a systemic software application, the present invention produces personalized products for a consumer or production runs for a manufacturer. Then consumer can enter self-describing information such as but not limited to age, sex, location, and composition-related needs, including but not limited to medical, therapeutic, and cosmetic needs. In the case of cosmetics, the system may further embody deployment of a facial scanning application configured to scan a consumer's face to determine dermatological properties by measuring, for instance, whether the facial skin is dry, oily, or a combination of skin types, etc. In the case of a drug or supplement, the system embodies deployment of a biomarker system configured to determine health properties such as but not limited to vitamin, or mineral levels to determine whether the subject or customer maintains the right or adequate levels, of such vitamins or minerals, etc. The systemic application uses algorithms to compare the sensed dermatologic or biologic properties against thousands of customer/patient properties retrievably stored within a database. For instance, in the case of cosmetics, the system would compare the sensed skin type against an index or table of no less than 10,000 skin types from the said dermatological properties database. The system employes recommendation software, whereby ingredients are recommended to the individual for what they need, and these ingredient options are queued into the robotic system. The ingredients are selected and composed in a formula so that a front-end compositional robot can make a single product personalized to a customer and needs.

At this point the autonomous workflow starts to function, and the robots in the operating theatre take over. The robotic arm 10 picks an empty input container 14 which will also serve as the finished container from an onboard container repository or bin. The primary container for compounding is placed in a specified location for fill and formulation pipetting. The specified location may be operatively associated with a load cell or the like, thereby serving as a weigh scale where the empty container is weighed prior to formulation and the ingredients are measured for accuracy.

Onboard, within the operating theatre, a plurality of ingredients (including solids, liquids, or powders) are preloaded for access by the front end compositional robotic arm 10. Once the input container 14 is weighed, the scale is automatically zeroed out so the ingredients of the formula can be individually precision measured. The formulation or compounding begins whereby robotic arm 10 with onboarded formula for formulation, moves to the pipettor station and selects a pipettor from a pipettor rack commensurate with the volume of ingredients needed. The robotic arm 10 then moves to a pipette tip supply location where the robotic arm 10 attaches a clean pipette tip to the pipettor 12. The robot moves the resulting pipettor assembly to the first of multiple ingredients of the formula, where the robot manipulates the pipettor to pick up the amount of ingredient defined by the formula. The robotic arm then moves that ingredient to the input container 14 where it ejects or transfers the ingredient into the input container 14. The robotic arm then moves to a pipette tip waste bin where the pipette tip is ejected to avoid any cross contamination between formula's ingredients. This process repeats for the plurality of ingredients or to a formulation or formula requirement.

Once all the ingredients or compounds are added the robot arm 10 picks up the input container 14 and (optionally) moves the product to a mixing stage where the product is vortex mixed to a predetermined time prescribed by the formula. Once mixed the robotic arm 10 move to a bulk cap bin where it picks up a bottle cap, moves to the container and places the cap onto the container, spinning the cap to seal the container with the formulated compound. The robotic arm 10 may pick up the sealed compound container and move it to a labeling station for a systemic label output phase, where a laser engraves all necessary information (“label parameters”) onto the container of the finished product, including but not limited to a logo, ingredient information, required FDA label information parameters, and the like. Once labeled, the robot moves the finished product to an exit conveyor 18 that transports the finished product to the automated logistics center.

The logistics centers work as follows. A myriad of finished products can come to the logistics center in the form of a plurality of single product formulations and/or a production run mass dumped onto a transport conveyor. The conveyor transports the finished product to a back end robotic manipulator of the automated logistics center which singles finished products out and moves each finished product in single file to an optical reading station.

The optical reading station visually inspects each product on a plurality of sides (for a generally cubic container, all six sides) where the detection system reads the barcode, 2D, 3D, or QR Code to identify the finished product via the label parameters associated with the labeling, contents including but not limited to expiration date, marker information, and size and/or strength.

Each finished product is then moved via a conveyor and introduced to the back end logistic robotics which may include but is not limited to one or more track grabbers with approximately eighteen-inch fingers. The robotics grabs the product and moves it into a self-contained storage site within the system to place product for inventory.

Finished products are placed on a first-in, first-out basis for efficient retrieval, and loaded alpha numerically or by fast and slow movers. The machine sorts the finished product, takes inventory of the finished product, stores the product, and tracks and traces each item, manages recalls, manages inventory reorders, and controls the entire inventory environment.

When an order is placed, a secondary robot in the same machine grabs the required products singularly or in batches up to five products at one time. The products are moved to an exit station where optics verify the product matched to the order. After verification, the product exits through a dispensing chute and on to a conveyor which moves the product to a (optional) fully automated packaging line that forms boxes, drops the product into the formed box, prints informational sheets and places the informational sheets into the box, seals the box, prints and applies the shipping label to the box and moves the finished product to a loading station.

This is an end-to-end autonomous system that formulates products, packages the product, labels the products, sorts and inventories the finished products, manages products for inventory and orders, it dispenses orders on demand, packs orders and moves products to a pick-up station for delivery pickup.

The AI logistics robotics, via machine learning, learns ordering processes and habits, manages and controls product volumes and product level inventory to exponentially reduce inventory compared to traditional self-storage systems, and to reduce overall inventory in a just-in-time format to reduce redundancy and inventory volumes by 35%, thwarting over stock, while producing zero order errors.

The AI robotics technology uses AI techniques known as ‘symbolic AI’ or expert systems using rule-based procedures (e.g., algorithms) that a computer can follow, step by step, to decide how to respond intelligently to a given situation. The present invention may use “fuzzy logic” to capture intuitive knowledge, so that the algorithms can make good decisions in the face of wide-ranging and uncertain variables that interact with each other. The rules are strict, and the variables are unambiguous and quantifiable.

The learning process of algorithms through artificial neural networks functions like the brain, wherein Inputs are translated into signals which are passed through a network to generate outputs that are interpreted as responses to inputs, wherein a plurality of layers allows the neural networks to tackle more complex problems. Process development includes deep learning which simply refers to a neural network with several layers. This converts to machine learning (ML), transforming the network so that outputs are intelligent.

The systemic ML algorithms automate the robots learning process by making improvements to individual neural networks in large populations of data. Systemic AI algorithms exhibit intelligence in a wide range of contexts and problem spaces. In short, the system embodies AI robots that can perceive and act autonomously in a complex environment. Therein, the ML algorithms are used to enable the systemic robots to learn from their experiences and improve their performance over time. “Deep Learning” (DL) is utilized to solve specific problems that are difficult to solve with traditional machine learning techniques, including adaptive image and optical recognition functionality.

By combining these technologies, the advanced robotics systems can perform complex tasks that were once thought impossible. The relationship between them is inclusive in terms of analysis and modification of the advanced robotic systems. The present invention uses object detection and recognition for critical tasks to identify and classify objects in their environment with high accuracy. With predictive maintenance the system of the present invention can detect potential issues before they occur by analyzing data from sensors and predictive maintenance algorithms.

The present invention contemplates the assembly, formulation, compounding, manufacturing robotics with AI, ML, and DL technologies that work smarter, faster, and more efficiently than human counterparts to improve quality, reduce costs, and increase productivity. Controlled and optimized processes allow the robots to adapt to changing conditions and learn from experiences to improve future performance to optimize workflow in the development of new cosmetic, drug, nutraceutical, chemical, and/or cannabis product development to efficiently improve output and costs. The front-end robots tied to the supply chain optimization robotics all use AI and ML to optimize the complete production process through the supply chain process by predicting demand.

The computing devices of the system, including those operatively associated with the above-mentioned robotics, may provide information transfer and digital data communication that requires that communicated data contains the following: weight information and all data provided in label parameters; sample ID; ingredient name; ingredient amount; required vortex time; number of samples to be produced of the relevant ID, wherein data needs to be shared in one of the following ways: through robot web services, editing a custom RAPID variable; through file transferred to FTP server; or through socket communication. Any option will need to be presented to the robot's local network by means of a LAN connection. The system may be extraneous to any internet connection, VPN, etc.

In one embodiment, the front-end formulation robotics communicates to the back-end logistics robotics via a connected neural network which is an artificial mathematical model used to approximate functions. This is implemented in the software. Neurons in the artificial neural network are arranged into layers, with information passing from the first layer (the input layer) through one or more intermediate layer and on to the final layer (the output layer). The “signal” input to each neuron is a number, specifically in a linear combination of the outputs between connected neurons in the previous layer. The signal each neuron outputs is calculated from this number, according to its function. The behavior of the network depends on the level of the connection between neurons in the front-end to the back-end robotics. The front-end network trains the back-end network by modifying these weights or connections through what is known as empirical risk mitigation to fit the preexisting dataset in the front-end. For each event there is a set of values such as x1, x2, y1, y2, z etc. Our 2 networks undergo two phases of communication. The first network takes x1, x2 as inputs and outputs z. The second neural network receive output z and interpolates is as y1, y2 as inputs and outputs b. The communication process includes (1) a first phase, wherein the first neural network is trained with inputs x1, x2 to output z and the second neural network takes output z and interprets this input as y1, y2 to create its own output b; and a (2) second phase when inputs and outputs are ready to go of z and b, they look for a value that is somewhere between z and b and minimize the difference between their outputs (i.e. for each output, NN1 and NN2, where NN2 is trained on the output of NN1. The system automatically updates the weights and biases of each. Then, use the new weights and biases to calculate a new output for each. Then the system goes through another training round from NN1 to NN2 thereby training NN2 the output requirements of NN1. Simply put, the systemic network carries out tasks between the front-end formulation robot and back-end logistics robot solely based on communicated instructions. The front-end AI describes what it learned to its back end “sister” AI, which performs tasks despite having no prior training or experience in doing it.

In both the front-end robotics and back-end logistics robotics the present invention utilizes object detection and recognition via AI and ML algorithms to identify and recognize different objects, movements, and processes in the manufacturing environment to navigate and create new product formulations in less than three minutes per new product. The system also uses real-time decision-making AI algorithms to enable robotics to make real-time decisions based on sensor data, allowing them to adapt to changing conditions in a manufacturing environment. Path optimization AI algorithms are also incorporated to optimize the path or sequence that the physically remote robotic elements take to collectively manufacture products. With fifty ingredients onboard in the operating theater, the system can make greater than 500,000 different formulations.

Uniquely, the robotics of the present invention also learn from demonstration with ML and DL algorithms our robots are able to learn from a human where the operator shows the robot how to perform a task which enables the robots to quickly learn that new task and adapt the new additions or changes.

This entire sequence of events creates a product or formulation from the multiple components (“raw ingredients”) to finished product and inventories finished products (sort, inventory, track, trace, serialize, code, manage inventory, and dispense) and manages them for inventory control and distribution.

The system enables electronic devices, such as a tablet, cell phone, computer, or onboard screen, to pick from a predesignated pick list of ingredients to selectively adjust the formulation process. As mentioned above, the system, via robotic manipulation, pulls the raw ingredients, sequentially adds them to an empty input container 14, stirs and heats the product if necessary, and the front end robotic arm 10 is enabled to cap and seal the input container 14, wherein subsequent robotic functionality is configured to laser print required formulation or label data/parameters and take finished product though full inventory management.

A method of making the present invention may include the following components: AI and optical scanning technology is configured to manage raw ingredients; robotics software for robotic control; a fully articulated robotic arm or plurality of articulated robotic arms; full inventory control software; pick and put robotics; and end of line automated box erection, box filler, box sealer, label printer, label applicator, and track and trace software are contemplated. The present invention, with very minor changes, can be used to produce formulations in the chemical, CBD, cosmetic, drug, and supplement markets.

A method of using the present invention may include the following steps: filling the container bin with various sizes of input containers 14 and caps in a cap bin. Then the operator or customer would choose ingredients for formulation whereby fifty ingredients could make 1 to 500,000 different formulations. Once ingredients and ingredient amounts are chosen and composed in a formula, the operator runs the system for making a compound product from scratch in less than three minutes, from raw ingredients to final product.

Additionally, the present invention embodies a process for making compounded products and/or compositions from raw ingredients as well as for co-packing purposes in the respective fields.

In the context of preparing cosmetic products, the essence of the formulation process embodied herein is for the preparation of individualized formulations for drugs, nutraceuticals, chemicals, cosmetics, and CBD.

The present invention embodies robotic systems and methods that utilize AI robotic devices, specifically methods for guiding a robot arm to create a formulation from a formula. The AI further enables formula review, options for changing the formula, storage of the formula, customer information input and storage, product making, product closing, label printing of product information, product sorting, storing, managing inventory, and product packing. The process allows the possibility of on-demand creation of formations of a wide variety of compositions for a wide variety of industries.

In this context, the present invention would provide the following inventive advantages: high-speed autonomous robotic on-demand formulation, compounding and/or production in communication with back-end logistics robotics that facilitate the validation process to eliminate errors. As a result, the present invention enables efficient high-volume preparation of unique products with zero waste; automating the process of R&D formulation, production runs, short runs, and co-packing by picking, adding, filling, and printing (laser engraved); and a design that enables rapid reconfiguration to do an entirely different order minutes later.

The present invention further embodies rapid product customization with diagnostics, whereby greater than 500,000 formula variations can be produced through complex algorithms that control and manage the level of concentration and ratio between different ingredients.

The present invention embodies plug and play integration. The present invention is adapted to provide 100% fully autonomous automation of ordering, formulation, production, packing and distribution. The formulation process of the present invention includes a mixing system configured to efficiently mix highly viscose products in small volumes (e.g. 15 mL or 30 mL) in seconds and provide micro dosing capabilities (approximately 0.024 mL). The present invention automates the process of ordering, adding ingredients, filling, mixing, weighing, and branding into one single step. Automated high-speed production of the present invention includes instant reconfiguration after every unique product (each one prepared in minutes). The present invention includes holistic supply chain technology, so that products are produced fresh on-demand when an order is placed digitally. The present invention includes rapid product customization algorithms with diagnostics and an ordering solution, for limitless product variations. Enhanced sensor technology combined with multiple layers of quality steps and production in an aseptic environment is employed also ensure accuracy, traceability and reproductivity is provided.

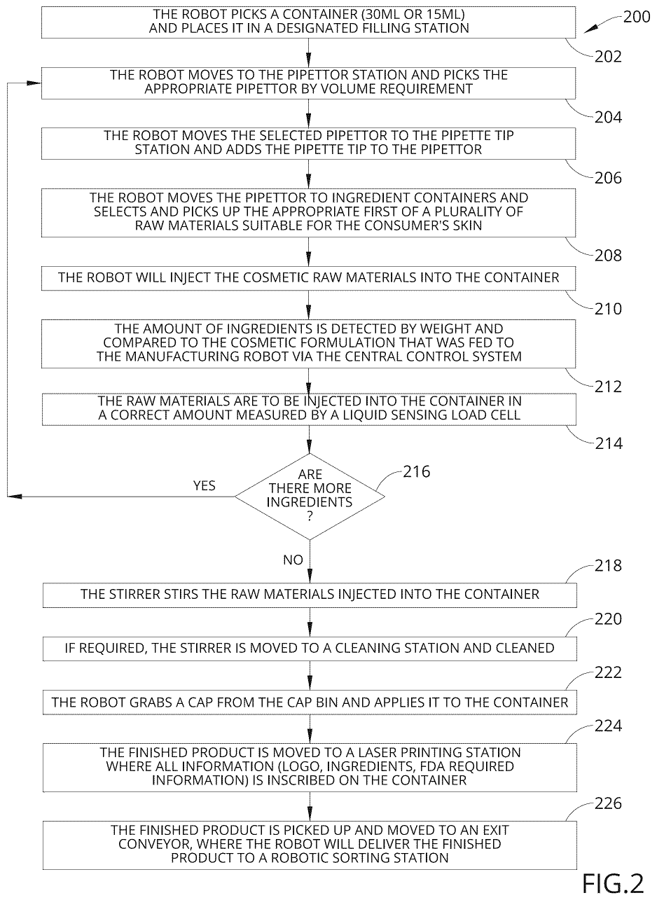

Referring to FIGS. 1 and 2, the automated formulation and delivery system may include front-end formulation robotics providing one or more robotic arms 10 in an operative environment, like the exemplary one shown in FIG. 1. The automated formulation and delivery system is operatively associated with one or more computing devices, not shown, with a user interface for an operator to input data. Such an input device enables a consumer to self-describe properties for a desired composition of drugs, cosmetics, CBD-edibles, chemicals, or nutraceuticals, resulting in a personalize formula from which the formulation and resulting compound is devised. Such input devices may be remote to the overall system and communicated over a network, such as the Internet.

The operative environment of the automated system may be organized into several stations based on a specific task assigned by the operative via the computing device that receives user-input instructions, processes these instructions and then prepares unit or doses of one or more formulations in accordance with the instructions and the formula composed from the user input.

The operating theater, or station, may provide storage for input containers 14, pipettes 12, pipettor racks 16, and pipette tips under proper conditions. Typically, raw ingredients or compounds and the like are stored in sealed compound containers, and the pipettes 12 permit the controlled drawing, transportation and dispensing a measured volume of a compound.

Several of the stations are arranged within “arm's length” around the articulatable robotic arm 10 so that the robotic arm 10 picks a compound container and places it in a designated filling container. the robotic arm 10 may then be instructed to move to the pipettor station and pick the appropriate pipettor 12 by volume requirement. The robotic arm 10 moves and selects the appropriate pipettor 12 and adds the pipette tip to the pipettor 12. The robotic arm 10 moves the pipettor 12 to the compound containers and selects and picks up the appropriate first of a plurality of raw materials suitable for the desired formulation instructed by the operator via the computing device. The robot will inject the raw material/compound into an input container 14. The number of ingredients/compounds is detected by weight and compared to the formulation that was fed to the manufacturing robot via the central control system. The raw materials are to be injected into the input container 14 in a correct amount measured by, for instance, a sensing load cell in accordance with the relevant formula.

The load cell may be any transducer for the measurement of force or weight, usually based on a strain gauge bridge or vibrating wire sensor. The load cell is part of an overall automated formulation and delivery system and therefore contains software that communicates with the central control system so that the operation of the complete system can be controlled in concert with the movement of the front-end robotic arm 10 and the back-end logistic robotics.

Once there are no more ingredients/compounds needed to be added to the input container 14, the system stirs the raw materials in the input container 14. If required, the stirrer is moved to a cleaning station and cleaned.

The robotic arm 10 may then be instructed to grab a cap from a cap supply station and applies the cap to the input container 14. The finished product of the capped/sealed input container 14 may be moved to a laser printing station where all information/label parameters (logos, ingredients, FDA required information) may be inscribed on the container via a label. The finished product/formulation is picked up and moved to an output conveyor 18, where the robot will deliver the finished product to a robotic logistics center. The automated formulation and delivery system also preferably includes a reader that can read a label on the sealed container containing the formulation. The label is read using any number of suitable reader/scanner/camera devices, such as a bar code reader, etc., to confirm that the proper formulation has been selected for placement in the storage unit, such information may be associated with the label parameters.

Labels for the equipment (e.g., container supply rack), the containers of the raw ingredient, and the packaged formulation may provide a unique identifier, such as a barcode or RFID that uniquely identifies the equipment, the raw ingredient, the packaged formulation to monitor, track, and dispense (in batches) such items.

The central control system, operatively associated with the user interface of the remote computing device through wireless communications, is configured to integrally manage the plurality of raw ingredients and formulations.

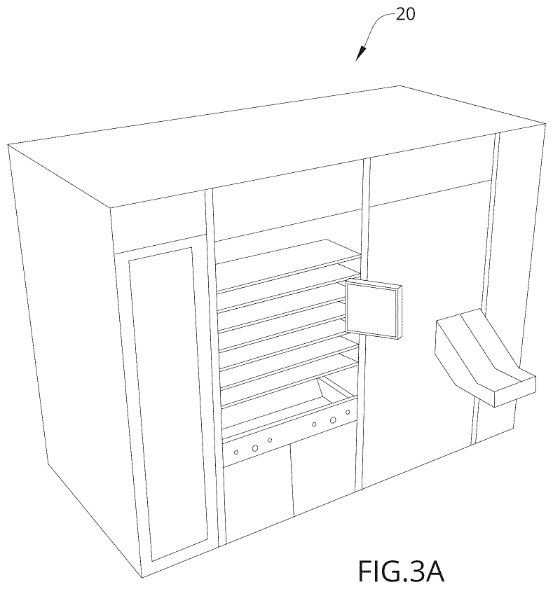

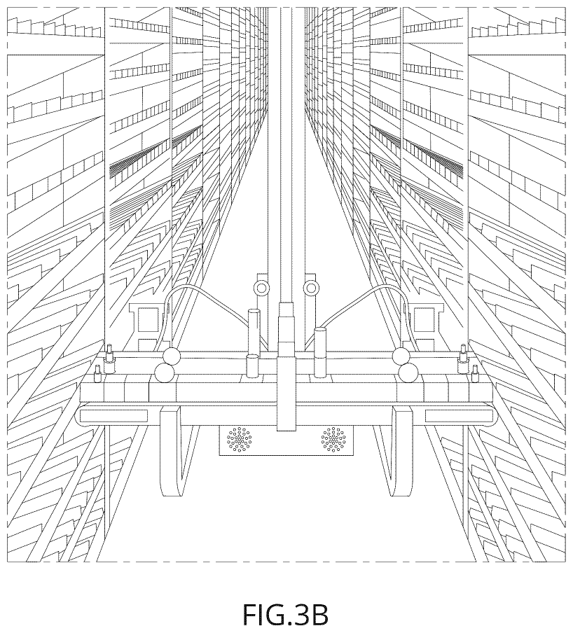

Referring to FIG. 3, the present invention provides a robotic sorting station 20 configured to singulate the packaged product and visually/optically inspect the product on all sides, wherein the optical system will pick up any barcode or QR code to identify the product, package content, manufacturer, lot number, expiration date, or any identifiers. An identified product that's moved into the storage system may be alphanumerically placed on shelves. information managed and controlled will include barcode, QR code, product name, manufacturer information, product size or weight, expiration date, lot or SKU information, and inventory control for automatic record.

The system of the present invention will manage first-in first-out and recalls so that when an order comes in, the front-end robot arm 10 will pick up the products and batch them to order; the system will develop a pick list and include it with the shipment; products batched will be delivered to an exit station where they will be conveyed to a packing system. In a packaging system of the present invention, the packaging system will form a box of appropriate size for each batch; each batch will be automatically placed in the box and appropriate paperwork printed for the order will also be included. Then it is determined if manual or automatic final packaging is in order. If the packaging is to be automatic, then the box will be taped and sealed; system for automatic packing, the box will be closed and sealed, a customer label will be printed and applied to the box; and the system will move the packed box via conveyor to a pick up location based on destination of delivery; at pick up location, a truck driver will load packages.

The present invention safeguards the supply chain, enables zero error (logistics robotics) and zero waste (formulation robotics), produces a 360-degree product audit trail, self-monitors inventory, expiration and recalls, provides track, trace, and serialization, quantifies product strengths, provides a turnkey system designed for regulatory and GMP, standardizes the entire process of formulation, and runs compounding, co-packing, short run manufacturing and full production manufacturing.

The present invention provides standard manufacturing and logistics that currently require 125,000 to 150,000 sq. ft. in just 2000 sq. ft. and takes the prior art sixteen-hour shift is reduced to four hours.

The formulation process of the present invention is a user-friendly platform providing the following: diagnostic tools; ingredient management; portal advanced formulation algorithm; scientifically validated natural formulations; and regulatory approvals for product efficacy and compliance.

The packaging system of the present invention provides the following: laser engraving system; a dual bottle system; an integrated mixer; and flexible packaging choices.

The production system of the present invention provides the following: full autonomy; zero minimum orders with rigorous quality control; and rapid, waste-free production.

The distribution system of the present invention provides a QR system for real-time tracking.

The robotics system of the present invention provides the following: robotics rapid reconfiguration; precise mixing of viscous materials; end-to-end automation; and micro-dosing for high viscosity ingredients.

The present invention embodies software as a service (SaaS) comprehensive software solution that covers orders, formulation, production, packing, and distribution; and enables seamless client integration.

The server and the computer of the present invention may each include computing systems. This disclosure contemplates any suitable number of computing systems. This disclosure contemplates the computing system taking any suitable physical form. As example and not by way of limitation, the computing system may be a virtual machine (VM), an embedded computing system, a system-on-chip (SOC), a single-board computing system (SBC) (e.g., a computer-on-module (COM) or system-on-module (SOM)), a desktop computing system, a laptop or notebook computing system, a smart phone, an interactive kiosk, a mainframe, a mesh of computing systems, a server, an application server, or a combination of two or more of these. Where appropriate, the computing systems may include one or more computing systems; be unitary or distributed; span multiple locations; span multiple machines; or reside in a cloud, which may include one or more cloud components in one or more networks. Where appropriate, one or more computing systems may perform without substantial spatial or temporal limitation of one or more steps of one or more methods described or illustrated herein. As an example, and not by way of limitation, one or more computing systems may perform in real time or in batch mode one or more steps of one or more methods described or illustrated herein. One or more computing systems may perform at different times or at different locations, one or more steps of one or more methods described or illustrated herein, where appropriate.

In some embodiments, the computing systems may execute any suitable operating system such as IBM's ZSeries/Operating System (z/OS), MS-DOS, PC-DOS, Mac-OS, Windows, Unix, OpenVMS, an operating system based on Linux, or any other appropriate operating system, including future operating systems. In some embodiments, the computing systems may be a web server running web server applications such as Apache, Microsoft's Internet Information Server™, and the like.

In particular embodiments, the computing systems include a processor, a memory, a user interface and a communication interface. In particular embodiments, the processor includes hardware for executing instructions, such as those making up a computer program. The memory includes main memory for storing instructions such as computer program(s) for the processor to execute, or data for processor to operate on. The memory may include mass storage for data and instructions such as the computer program. As an example, and not by way of limitation, the memory may include an HDD, flash memory, an optical disc, a magneto-optical disc, a Universal Serial Bus (USB) drive, a solid-state drive (SSD), or a combination of two or more of these. The memory may include removable or non-removable (or fixed) media, where appropriate. The memory may be internal or external to computing system, where appropriate. In particular embodiments, the memory is non-volatile, solid-state memory.

The user interface may include hardware, software, or both providing one or more interfaces for communication between a person and the computer systems. As an example, and not by way of limitation, a user interface device may include a keyboard, keypad, microphone, monitor, mouse, printer, scanner, speaker, camera, tablet, touchscreen, trackball, video camera, another suitable user interface or a combination of two or more of these. A user interface may include one or more sensors. This disclosure contemplates any suitable user interface.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the invention and that modifications may be made without departing from the spirit and scope of the invention as set forth in the following claims.

What is claimed is:

1. A system for autonomously formulating a topical or consumable composition tailored to a consumer, the system comprising:
an input device configured to receive one or more composition parameters from the consumer;
a recommendation module configured to receive the one or more composition parameters and compose, in part by referencing a composition database, a formula of two or more compounds, wherein each compound is associated with the one or more composition parameters by the recommendation module;
a workstation comprising a programmable front-end robot and a plurality of compounds, wherein the front-end robot is programmed via artificial intelligence to form, based on said formula, the topical or consumable composition in an input container;
a labeling component configured to label the input container, wherein the label comprises label parameters that include a weight of the formed topical or consumable composition; and
a logistics center comprising:
a reader configured to read the label parameters;
a load cell; and
a back-end robot configured to validate the labeled input container by comparing the weight the reader reads from the label against a determined weight determined by the load cell.

2. The system of claim 1, wherein the logistics center is configured to render the label parameters into a set of instructions so that the back-end robot sorts and tracks the labeled input container.

3. The system of claim 2, further comprises a conveyor system interconnecting the workstation, the labeling component, and the logistics center.

4. The system of claim 3, wherein the input device further comprises a facial scanner configured to determine one or more dermatological properties of the consumer, and wherein the compositional parameters comprise the one or more dermatological properties.

5. The system of claim 4, wherein the compositional parameters further comprise self-described parameters input into the input device by the consumer.

6. The system of claim 3, wherein the input device further comprises a facial scanner configured to determine one or more biological properties of the consumer, and wherein the compositional parameters comprise the one or more biological properties.

7. The system of claim 6, wherein the compositional parameters further comprise self-described parameters input into the input device by the consumer.

8. A method of producing and distributing a plurality of compositions, the method comprising:
formulating the plurality of compositions by way of front-end formulation robotics;
determining, by way of the front-end formulation robotics, a weight of each composition of the plurality of compositions;
labeling each said composition with compositional parameters that include the determined weight;
conveying, by way of a conveyor system, each said composition to a logistics center having back-end logistics robotics, wherein the conveyor system directly and physically connects the logistics center and the front-end logistics robotics by a distance that is no more than ten feet;
electronically communicating the determined weight for each composition from the front-end formulation robotics to the back-end logistics robotics; and
validating each composition by comparing the communicated determined weight against a weight determined by the back-end logistics robotics.

9. The method of claim 8, wherein the front-end robotics communicates to the back-end logistics robotics via a connected neural network.
